(19) United States
(12) Patent Application Publication
(10) Pub. No.: US 2024/0398016 A1
(43) Pub. Date: Dec. 5, 2024

(54) AEROSOL GENERATING DEVICE

(71) Applicant: KT&G CORPORATION, Daejeon (KR)

(72) Inventors: Sangkyu PARK, Seoul (KR); Daenam HAN, Seoul (KR); Jongsub LEE, Gyeonggi-do (KR); Wooseok CHUNG, Gyeonggi-do (KR); Byungsung CHO, Gyeonggi-do (KR)

(73) Assignee: KT&G CORPORATION, Daejeon (KR)

(21) Appl. No.: 18/698,006

(22) PCT Filed: Oct. 18, 2022
(86) PCT No.: PCT/KR2022/015843

§ 371 Date: Apr. 2, 2024

(30) Foreign Application Priority Data
Oct. 19, 2021 (KR) 10-2021-0139807
Mar. 10, 2022 (KR) 10-2022-0030271

(51) Int. Cl. A24F 40/465; A24F 40/10; A24F 40/42; A24F 40/485

(52) U.S. Cl. CPC A24F 40/465; A24F 40/10; A24F 40/42; A24F 40/485

(57) ABSTRACT

An aerosol generating device is provided. The aerosol generating device according to the present disclosure includes: a container having an outer wall defining a storage space in which an aerosol generating material is stored; a member forming at least a portion of the outer wall of the container and configured to absorb the aerosol generating material; a susceptor disposed adjacent to the member and configured to heat the member; and a coil comprising a pan coil wound a plurality of times from an innermost turn to an outermost turn, the coil being disposed adjacent to the susceptor and configured to inductively heat the susceptor.

### TECHNICAL FIELD

The following description relates to an aerosol generating device.

### BACKGROUND ART

An aerosol generating device is a device that extracts certain components from a medium or a substance by producing an aerosol. The medium may contain a multicomponent substance. The substance contained in the medium may be a multicomponent flavoring substance. For example, the substance contained in the medium may include a nicotine component, an herbal component, and/or a coffee component, and the like. Recently, active research has been conducted on the aerosol generating device.

### DISCLOSURE

### Technical Problem

It is an objective of the present disclosure to solve the above and other problems.

It is another objective of the present disclosure to remove a structure for electrically connecting a power source and a cartridge for storing an aerosol generating material.

It is yet another objective of the present disclosure to effectively transfer heat, provided by a susceptor, to an absorbing member containing the aerosol generating material.

### Technical Solution

In accordance with an aspect of the present disclosure for accomplishing the above objectives, there is provided an aerosol generating device comprising: a container having an outer wall defining a storage space in which an aerosol generating material is stored; a member forming at least a portion of the outer wall of the container and configured to absorb the aerosol generating material; a susceptor disposed adjacent to the member and configured to heat the member; and a coil comprising a pan coil wound a plurality of times from an innermost turn to an outermost turn, the coil being disposed adjacent to the susceptor and configured to inductively heat the susceptor.

### Advantageous Effects

According to at least one of the embodiments of the present disclosure, stability of an aerosol generating device may be improved by removing an electrical connection structure between a power source and a container.

According to at least one of the embodiments of the present disclosure, a coil for heating a susceptor may be formed as a pan coil, such that the susceptor may be effectively heated by induction heating.

According to at least one of the embodiments of the present disclosure, an inductively heated susceptor may be maintained in contact with an absorbing member containing an aerosol generating material.

Further scope of applicability of the present disclosure will become apparent from the detailed description given hereinafter. However, it should be understood that the detailed description and specific examples, while indicating preferred embodiments of the present disclosure, are given by illustration only, since various changes and modifications within the spirit and scope of the present disclosure will become apparent to those skilled in the art from this detailed description.

### DESCRIPTION OF DRAWINGS

FIGS. 1 to 7 are diagrams illustrating examples of an aerosol generating device according to embodiments of the present disclosure.

### MODE FOR INVENTION

Hereinafter, embodiments of the present disclosure will be described in detail with reference to the accompanying drawings, in which the same or similar elements are designated by the same reference numerals, and a redundant description thereof will be omitted.

The terms “module” and “unit” for elements used in the following description are given simply in view of the ease of the description, and do not have a distinguishing meaning or role.

In addition, it will be noted that a detailed description of known arts will be omitted if it is determined that the detailed description of the known arts can obscure the embodiments of the present disclosure. Further, the accompanying drawings are used to help easily understand various technical features and it should be understood that the embodiments presented herein are not limited by the accompanying drawings, and the present disclosure should be construed to extend to any alterations, equivalents and substitutes in addition to those which are particularly set out in the accompanying drawings.

It will be understood that, although the terms first, second, etc., may be used herein to describe various elements, these elements should not be limited by these terms. These terms are only used to distinguish one element from another.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

As used herein, the singular forms are intended to include the plural forms as well, unless the context clearly indicates otherwise.

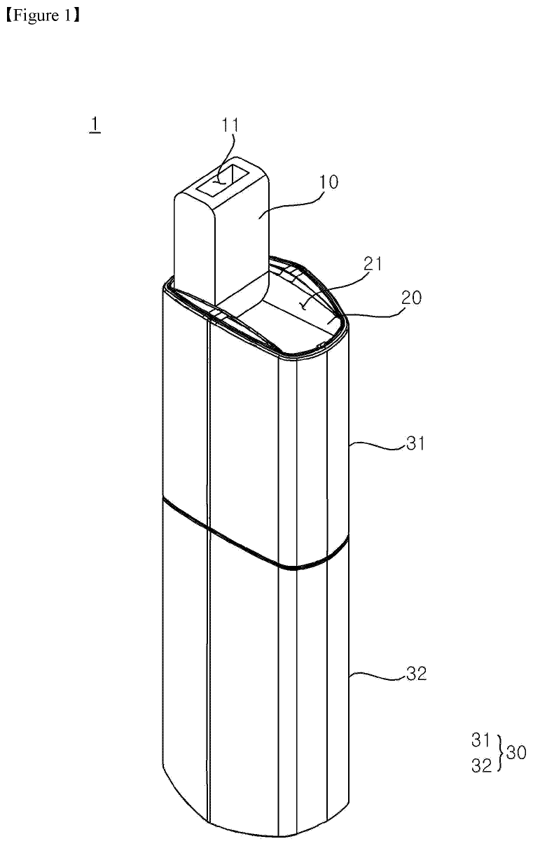

FIG. 1 is a perspective view of an aerosol generating device 1 according to an embodiment of the present disclosure. Referring to FIG. 1, the aerosol generating device 1 may include a casing 30, a cap 20, a mouthpiece 10, a cartridge 40, and a main body 50.

The casing 30 may form the exterior of the aerosol generating device 1 along with the cap 20. The casing 30 may include the upper part 31 and the lower part 32. The cartridge 40 and the main body 50 may be disposed in the casing 30. An inner surface of the upper part 31 may be coupled to an outer surface of the cartridge 40. An inner surface of the lower part 32 may be coupled to an outer surface of the main body 50. The upper part 31 and the lower part 32 may form a continuous outer surface. A user may hold the aerosol generating device 1 by gripping an outer surface of the casing 30.

The cap 20 may be coupled to the upper part 31. The mouthpiece 10 may be rotatably coupled to the cap 20. The cap 20 may include a receiving portion 21 in which the mouthpiece 10 is received. The receiving portion 21 may be recessed into the aerosol generating device 1. The mouthpiece 10 may be rotated to be received in the receiving portion 21. The mouthpiece 10 having a hollow shape may have a flow path (not shown) formed therein, through which air flows. A user may inhale aerosol, generated in the aerosol generating device 1, through the mouthpiece 10.

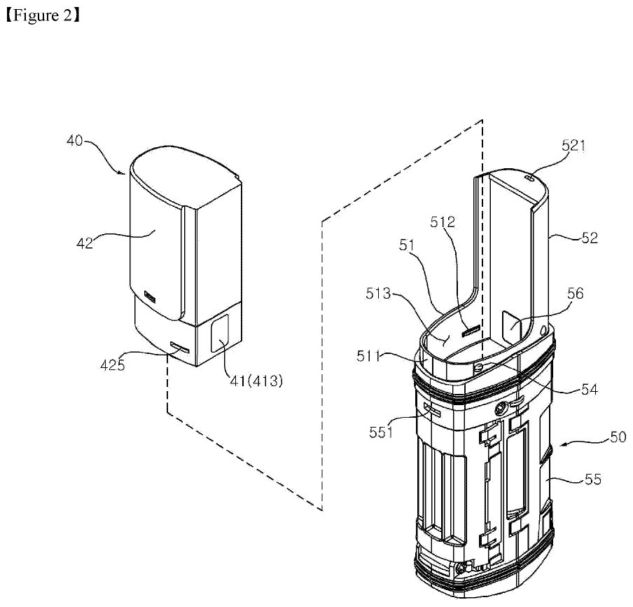

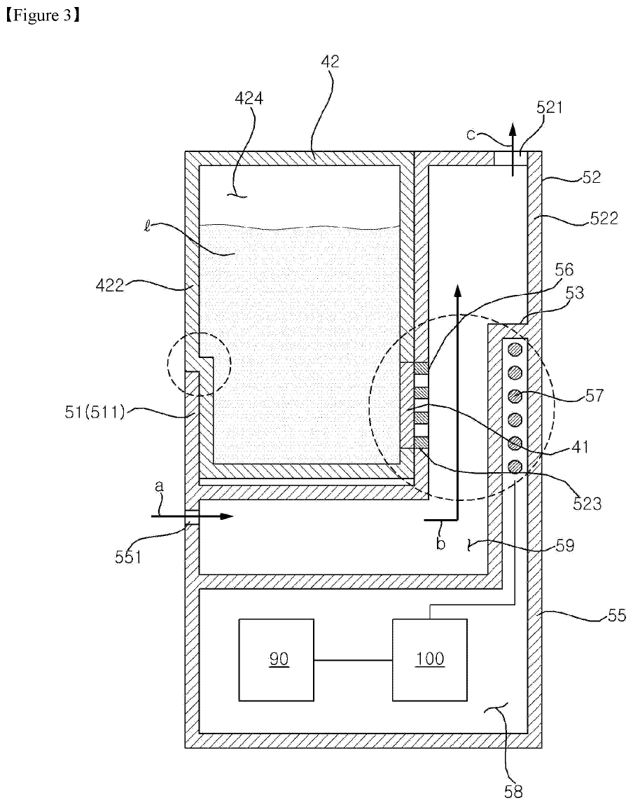

FIG. 2 is a diagram illustrating the cartridge 40 and the main body 50 according to an embodiment of the present disclosure. FIG. 3 is a cross-sectional view of the cartridge 40 and the main body 50 according to an embodiment of the present disclosure. Referring to FIGS. 2 and 3, the cartridge 40 may include an absorbing member 41 and a container 42. The aerosol generating device 1 may include a power source 100 and a controller 90.

The container 42 may contain an aerosol generating material 1. The container 42 may be removably coupled to the main body 50. The container 42 may have an elongated shape. The container 42 may be covered by the casing 30.

The absorbing member 41 may form at least a portion of an outer wall of the cartridge 40. The absorbing member 41 may have an outer surface which forms a continuous surface with an outer surface of the container 42. The absorbing member 41 may absorb the aerosol generating material 1 contained in the container 42. The absorbing member 41 may hold the liquid 1. For example, the absorbing member 41 may be made of a ceramic material. The ceramic material may have pores formed therein. The liquid 1 may be held in the pores.

The absorbing member 41 may have a shape corresponding to a shape of a susceptor 56. For example, the absorbing member 41 and the susceptor 56 may be formed in a plate shape. When the cartridge 40 is mounted to the main body 50, the absorbing member 41 may come into contact with the susceptor 56. The absorbing member 41 may pass through a portion of an outer wall 422 of the container 42. The absorbing member 41 may come into contact with the container 42. The absorbing member 41 may have one surface connected to the aerosol generating material 1 and another surface exposed to the outside of the cartridge 40.

The aerosol generating material 1 may be in a liquid state at room temperature. The aerosol generating material 1 may be referred to as a liquid. The aerosol generating material 1 in a liquid state may be atomized and/or vaporized by heat.

The aerosol generating material absorbed by the absorbing member 41 may be vaporized or atomized into aerosol by the susceptor 56 which is inductively heated, to flow (b) in a flow space 59. Along with outside air (a) introduced into the flow space 59 through a through-hole 551, the aerosol may flow (c) to the outside through the mouthpiece 10.

The container 42 may include an outer wall 422, a storage space 424, and a groove 425.

The outer wall 422 may define the storage space 424 therein, in which the aerosol generating material 1 is stored. The outer wall 422 may be elongated. When the cartridge 40 is mounted to the main body 50, a portion of the outer wall 422 which is elongated may be inserted into an installation space 513. The outer wall 422 may be made of a translucent or transparent material. The outer wall 422 may be made of a nonconductive material.

The groove 425 may be formed in an outer surface of the container 42. The main body 50 may have a protrusion 512 coupled to the groove 425. The container 42 may have a plurality of grooves 425, and the main body 50 may have a plurality of protrusions 512. The grooves 425 of the container 42 and the protrusions 512 of the main body 50 may be disposed at corresponding positions to be coupled to each other. Unlike this embodiment, the container 42 may have a protruding portion, and the main body 50 may have a recessed portion in which the protruding portion is received.

The main body 50 may include a lateral wall 51, a column 52, a coil housing 53, a protrusion 54, a main body housing 55, a susceptor 56, a coil 57, a mounting space 58, and the flow space 59.

The protrusion 54 may be formed on an outer surface of the main body 50. The casing 30 may be coupled to the protrusion 54 of the main body 50. There may be a plurality of protrusions 54. The protrusions 54 may be formed on an outer surface of the lateral wall 51 and the column 52.

The main body housing 55 may have the mounting space 58 formed therein. The controller 90 and the power source 100 may be accommodated in the mounting space 58. The main body housing 55 may be connected to the coil housing 53. The main body housing 55 may be integrally formed with the coil housing 53. The main body housing 55 may have the through-hole 551. The through-hole 551 may communicate with the outside of the main body 50. The flow space 59, communicating with the through-hole 551, may be formed in the main body housing 55. The flow space 59 of the main body housing 55 may be separated from the mounting space 58. The lateral wall 51 and the column 52 may extend from the main body housing 55.

The lateral wall 51 may be disposed on an outer surface of the main body housing 55. The lateral wall 51 may extend by protruding from the outer surface of the main body housing 55. The lateral wall 51 may define the installation space 513 therein, in which a portion of the container 42 is installed. The lateral wall 51 may have the protrusion 512 formed on an inner surface thereof. The protrusion 512 may protrude from the lateral wall 51 toward the installation space 513. The lateral wall 51 may be connected to the column 52. A portion of the container 42 may be inserted into the installation space 513 to be mounted to the main body 50. The groove 425 of the container 42 and the protrusion 512 of the lateral wall 51 may be coupled to each other.

The column 52 may be elongated in a direction in which the lateral wall 51 of the outer wall 422 protrudes. The column 52 may support the outer wall 422 of the container 42. A liquid volume sensor 62 may be disposed in the column 52. The column 52 may have a flow space 522 and a hole 521. The column 52 may have a hollow shape. An inner space of the column 52 may communicate with the flow space 59.

The hole 521 may communicate with the outside of the aerosol generating device 1. The hole 521 may communicate with the flow path (not shown) formed in the mouthpiece 10. The hole 521 may be disposed at one end of the column 52.

The generated aerosol and the air outside of the aerosol generating device 1 may sequentially pass through the through-hole 551, the flow spaces 59 and 522, the hole 521, and the flow path in the mouthpiece 10, to flow (c) to the outside of the aerosol generating device 1. The generated aerosol may flow together with the air outside of the aerosol generating device 1.

The coil 57 may be accommodated in the coil housing 53. The coil housing 53 may protrude from an inner surface of the column 52. The coil housing 53 may be made of a nonconductive material. The coil housing 53 may be made of a material through which an induced magnetic field passes. The induced magnetic field generated by the coil 57 may pass through the coil housing 53 to inductively heat the susceptor 56.

The susceptor 56 may form a portion of an outer wall of the column 52. The susceptor 56 may be mounted in the column 52 through a hole 523 formed in the column 52. The susceptor 56 may extend in a longitudinal direction of the column 52. For example, the susceptor 56 may be formed in a plate shape. The susceptor 56 may be made of a conductive material. The susceptor 56 may be inductively heated by the coil 57 to provide heat to a surrounding area. When the cartridge 40 is mounted to the main body 50, the susceptor 56 may be heated to provide heat to the absorbing member 41.

The coil 57 may be disposed to face the susceptor 56. The coil 57 may receive power from the power source 100. The coil 57 may generate the induced magnetic field. The coil 57 may inductively heat the susceptor 56.

The power source 100 may supply power to the aerosol generating device 1. The power source 100 may supply power to the controller 90 and the coil 57. The power source 100 may be a rechargeable battery or a disposable battery. For example, the power source 100 may be a lithium polymer (LiPoly) battery but is not limited thereto. The controller 90 may control an amount of power supplied from the power source 100 to the coil 57.

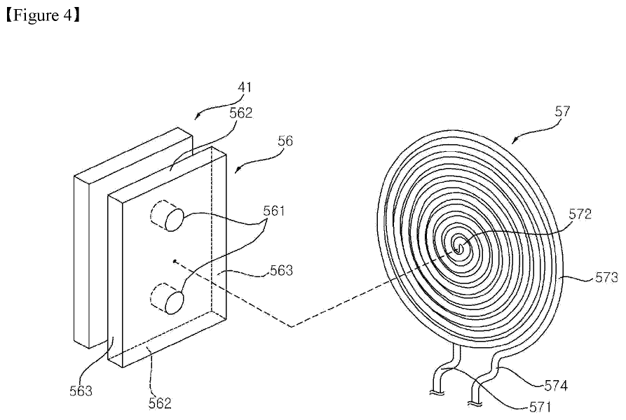

FIG. 4 is a diagram illustrating an arrangement relationship among the absorbing member 41, the susceptor 56, and the coil 57. The absorbing member 41, the susceptor 56, and the coil 57 may be arranged sequentially. The absorbing member 41, the susceptor 5, and the coil 57 may face each other.

The coil 57 may be wound with a plurality of turns from an innermost turn 572 to an outermost turn 573. The innermost turn 572 and the outermost turn 573 may be wound in a circular shape. The innermost turn 572 may be located outside of the outermost turn 573. The coil 57 may include a first wire 571 connecting the innermost turn 572 to the power source 100, and a second wire 574 connecting the outermost turn 573 to the power source 100.

When power is supplied from the power source 100 to the coil 57, the coil 57 may generate the induced magnetic field. The generated induced magnetic field may pass through the susceptor 56. A portion of the generated induced magnetic field may vertically pass through the susceptor 56.

The susceptor 56 may have a through-hole 561. There may be a plurality of through-holes 561. The aerosol generating material held in the absorbing member 41 may be atomized and/or vaporized by the susceptor 56 to flow to a flow path (b) through the through-holes 561. The susceptor 56 may include outer surfaces 562 and 563 disposed at positions surrounding the through-holes 56.

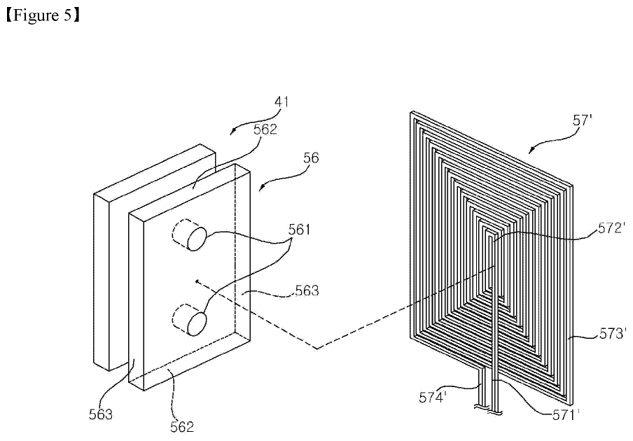

FIG. 5 is a diagram illustrating an arrangement relationship among the absorbing member 41, the susceptor 56, and a coil 57′. The absorbing member 41, the susceptor 56, and the coil 57′ may be arranged sequentially. The absorbing member 41, the susceptor 5, and the coil 57′ may face each other.

The coil 57′ may be wound with a plurality of turns from an innermost turn 572′ to an outermost turn 573′. The innermost turn 572′ and the outermost turn 83 may be wound in a rectangular shape. The innermost turn 572′ may be located outside of the outermost turn 573′. The coil 57′ may include a third wire 571′ connecting the innermost turn 572′ to the power source 100, and a fourth wire 574′ connecting the outermost turn 573′ to the power source 100.

When power is supplied from the power source 100 to the coil 57′, the coil 57′ may generate the induced magnetic field. The generated induced magnetic field may pass through the susceptor 56. A portion of the generated induced magnetic field may vertically pass through the susceptor 56.

The susceptor 56 may have the through-hole 561. There may be a plurality of through-holes 561. The aerosol generating material held in the absorbing member 41 may be atomized and/or vaporized by the susceptor 56 to flow to a flow path (b) through the through-holes 561.

The susceptor 56 may include the outer surfaces 562 and 563 disposed at positions surrounding the through-holes 561. The susceptor 56 may be formed as a rectangular plate. The first outer surface 562 and the second outer surface 563 may be orthogonal to each other. The susceptor 56 may have a rectangular cross-section formed by the outer surfaces 562 and 563. The coil 57′ may have a shape corresponding to a shape of the susceptor 56. The innermost turn 572′ and the outermost turn 573′ of the coil 57′ may be wound along a rectangular path.

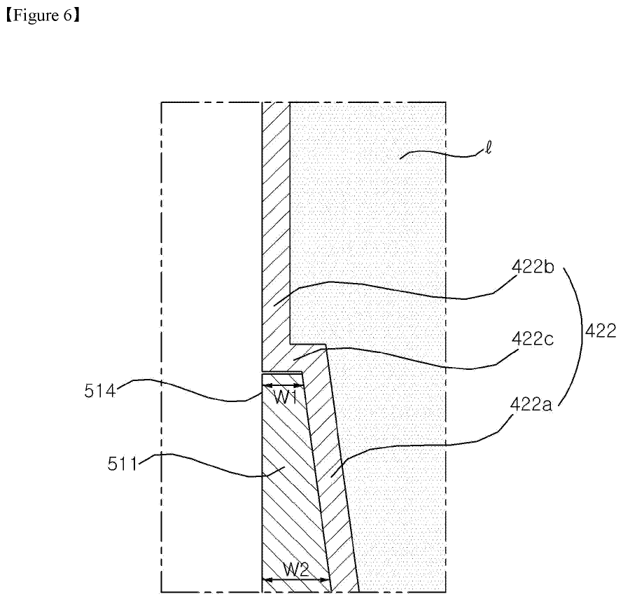

FIG. 6 is an enlarged view of a portion of FIG. 3. Referring to FIG. 6, the outer wall 422 of the container 42 may include a first extending portion 422a, a second extending portion 422b, and a connecting portion 422c.

The connecting portion 422c of the outer wall 422 may connect the first extending portion 422a and the second extending portion 422b. The first extending portion 422a and the second extending portion 422b may extend in the longitudinal direction of the container 42. The first extending portion 422a may extend in a direction intersecting the longitudinal direction of the container 42. For example, in a direction toward the main body housing 55, the first extending portion 422a may extend inwardly from the outer wall 422.

When the cartridge 40 is mounted to the main body 50, the first extending portion 422a may be disposed in the installation space 513. When the cartridge 40 is mounted to the main body 50, the second extending portion 422b may be disposed outside of the installation space 513. The connecting portion 422c may extend in a direction intersecting the longitudinal direction of the outer wall 422. For example, the connecting portion 422c may extend in a direction orthogonal to the longitudinal direction of the outer wall 422. The connecting portion 422c may be supported by a protruding end 514 of the lateral wall 51.

The lateral wall 51 may include a contact portion 511 which may be disposed at a position facing the hole 523 of the column 52. The contact portion 511 may support the first extending portion 422a. The contact portion 511 may come into contact with the first extending portion 422a. A thickness of the contact portion 511 may increase in a direction from the protruding end 514 of the lateral wall 51 toward the main body housing 55. In the direction from the protruding end 514 of the contact portion 511 toward the main body housing 55, an inner surface of the contact portion 511 coming into contact with the first extending portion 422a may be inclined toward the inside of the installation space 513.

A thickness W1 of the protruding end 514 of the contact portion 511 may be smaller than a thickness W2 of the contact portion 511 at a position adjacent to the main body housing 55. When the cartridge 40 is mounted to the main body 50, the container 42 may be in contact with the column 52 by the contact portion 511.

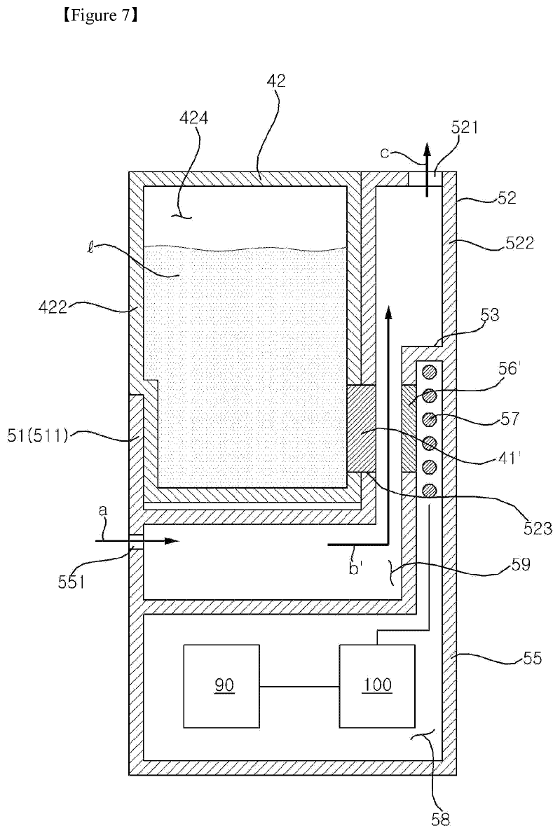

FIG. 7 is a diagram illustrating an aerosol generating device according to another embodiment which is different from those illustrated in FIGS. 1 to 6. Referring to FIG. 7, when the cartridge 40 is mounted to the main body 50, a portion of an absorbing member 41′ may be inserted into the hole 523 of the column 52. The absorbing member 41′ may face a susceptor 56′.

The absorbing member 41′ and the susceptor 56′ may be formed in a plate shape and may face each other. The susceptor 56′ may form a portion of an outer wall of the coil housing 53. The susceptor 56′ may be disposed inside the column 52. The susceptor 56′ may be disposed between the hole 523 of the column 52 and the coil 57.

A flow path (b) may be formed between the absorbing member 41′ and the susceptor 56′. Air (a) introduced through the through-hole 551 may flow to a flow path (b′). The susceptor 56′ inductively heated by the coil 57 may provide heat to the absorbing member 41′ disposed adjacent to the susceptor 56′. Aerosol atomized and/or vaporized by the provided heat may flow through the flow path (b′), to flow to the outside of the aerosol generating device through the hole 521.

Referring to FIGS. 1 to 7, an aerosol generating device 1 according to an embodiment of the present disclosure includes: a container 42 having an outer wall 422 defining a storage space 424 therein in which an aerosol generating material 1 is stored; an absorbing member 41 forming at least a portion of the outer wall 422 of the container 42 and absorbing the aerosol generating material 1; a susceptor 56 disposed adjacent to the absorbing member 41 and configured to provide heat to the absorbing member 41; and a coil 57 formed as a pan coil wound with a plurality of turns from an innermost turn 572 to an outermost turn 573, disposed adjacent to the susceptor 56, and inductively heating the susceptor 56.

According to another embodiment of the present disclosure, the aerosol generating device 1 may further include a flow path (b) formed between the susceptor 56 and the coil 57, wherein the susceptor 56 may be disposed between the absorbing member 41 and the coil 57 and may have through-holes 561 through which aerosol generated in the absorbing member 41 flows to the flow path (b).

According to another embodiment of the present disclosure, the aerosol generating device 1 may further include a main body 50 coupled to the container 42 and comprising a main body housing 55 in which a power source 100 electrically connected to the coil 57 is disposed.

According to another embodiment of the present disclosure, the outer wall 422 of the container 42 may be elongated, wherein the main body 50 may further include: a column 52 elongated from the main body housing 55 and supporting the outer wall 422 of the container 42; and a lateral wall 51 connected to the column 52 and protruding from the main body housing 55.

According to another embodiment of the present disclosure, the column 52 may include a coil housing 53 protruding from an inner surface of the column 52 and accommodating the coil 57.

According to another embodiment of the present disclosure, the lateral wall 51 may protrude from the main body housing 55 in a longitudinal direction of the column 52, defines an installation space 513 therein in which the container 42 is installed, and has a portion 511 facing the susceptor 56.

According to another embodiment of the present disclosure, the lateral wall 51 may include a contact portion 511 which comes into contact with a portion of the outer wall 422 of the container 42 when the container 42 is mounted to the main body 50, wherein the contact portion 511 may have thicknesses W1 and W2 which increase from a protruding end 514 of the lateral wall 51 toward the main body housing 55.

According to another embodiment of the present disclosure, the susceptor 56 may form a portion of an outer surface of the column 52 and may face the contact portion 511, wherein when the container 42 is mounted to the main body 50, the absorbing member 41 may be disposed between the contact portion 511 and the susceptor 56.

According to another embodiment of the present disclosure, when the container 42 is mounted to the main body 50, the susceptor 56 may come into contact with the absorbing member 41.

According to another embodiment of the present disclosure, the aerosol generating device may further include a flow path b′ formed between the susceptor 56′ and the absorbing member 41′.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol generating device comprising:
a container having an outer wall defining a storage space in which an aerosol generating material is stored;
a member forming at least a portion of the outer wall of the container and configured to absorb the aerosol generating material;
a susceptor disposed adjacent to the member and configured to heat the member; and
a coil comprising a pan coil wound a plurality of times from an innermost turn to an outermost turn, the coil being disposed adjacent to the susceptor and configured to inductively heat the susceptor.

2. The aerosol generating device of claim 1,
wherein a flow path is located between the susceptor and the coil,
wherein the susceptor is disposed between the member and the coil, and has through-holes through which an aerosol generated in the member is flowable to the flow path.

3. The aerosol generating device of claim 2, further comprising a main body coupled to the container, the main body comprising a main body housing in which a power source electrically connected to the coil is disposed.

4. The aerosol generating device of claim 3, wherein the outer wall of the container is elongated,
wherein the main body further comprises:
a column extending from the main body housing and supporting the outer wall of the container; and
a lateral wall connected to the column and protruding from the main body housing.

5. The aerosol generating device of claim 4, wherein the column comprises a coil housing protruding from an inner surface of the column and accommodating the coil.

6. The aerosol generating device of claim 4, wherein the lateral wall protrudes from the main body housing along a longitudinal direction of the column, defines an installation space in which the container is installed, and has a portion facing the susceptor.

7. The aerosol generating device of claim 6, wherein the lateral wall has a contact portion which comes into contact with a portion of the outer wall of the container when the container is installed to the main body, and
wherein the contact portion of the lateral wall has a thickness that increases along a direction leading from a protruding end of the lateral wall toward the main body housing.

8. The aerosol generating device of claim 7, wherein the susceptor forms a portion of an outer surface of the column and faces the contact portion of the lateral wall, and
wherein when the container is mounted to the main body, the member is disposed between the contact portion of the lateral wall and the susceptor.

9. The aerosol generating device of claim 8, wherein when the container is mounted to the main body, the susceptor comes into contact with the member.

10. The aerosol generating device of claim 1, wherein a flow path is located between the susceptor and the member.
